(19) United States
(12) Patent Application Publication
(10) Pub. No.: US 2008/0263134 A1
(43) Pub. Date: Oct. 23, 2008

(54) INFORMATION-PROCESSING SYSTEM, METHOD, COMPUTER-READABLE MEDIUM, AND COMPUTER DATA SIGNAL FOR CONTROLLING PROVISION OF INFORMATION OR PROCESSING SERVICE

(75) Inventor: Hiroaki Machida, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/744,902

(22) Filed: May 7, 2007

(30) Foreign Application Priority Data
Oct. 11, 2006 (JP) 2006277971

(51) Int. Cl. G06F 15/16

(52) U.S. Cl. 709/203

(57) ABSTRACT

There is provided an information processing system. The system has a first notice transmission unit that sends to a user first notice information made in correspondence to information or processing service provided by a processing device, a second transmission unit that sends to the user, when receiving from the user a request which contains at least a part of the first notice information, second notice information made in correspondence to information or processing service corresponding to the first notice information, and an instruction unit that instructs, when receiving from the user a request which contains at least a part of the second notice information, the processing device to provide the user with information or processing service corresponding to the second notice information.

### CROSS-REFERENCE TO RELATED APPLICATIONS

This application is based on and claims priority under 35 USC 119 from Japanese Patent Application No. 2006-277971 filed on Oct. 11, 2006.

### BACKGROUND

1. Technical Field

The present invention relates to an information-processing system, a method, computer-readable medium and a computer data signal for controlling provision of information or processing service.

2. Related Art

In recent years, as a method for providing information and service to specific users, electronic mails which contain a URL (Uniform Resource Locator) of a web page for providing the information or service is sent to the specific users.

### SUMMARY

According to an aspect of the invention, there is provided an information processing system. The system has a first notice transmission unit that sends to a user first notice information made in correspondence to information or processing service provided by a processing device, a second transmission unit that sends to the user, when receiving from the user a request which contains at least a part of the first notice information, second notice information made in correspondence to information or processing service corresponding to the first notice information, and an instruction unit that instructs, when receiving from the user a request which contains at least a part of the second notice information, the processing device to provide the user with information or processing service corresponding to the second notice information.

### BRIEF DESCRIPTION OF THE DRAWINGS

An exemplary embodiment of the present invention will be described in detail by reference to the following figures, wherein:

FIG. 1 is a diagram showing an example of a document management system to which a method of the embodiment is applicable;

FIG. 2 is a diagram showing an example functional structure of an MFP (digital multi-function peripheral);

FIG. 3 is a diagram showing the functional structure of the document management server;

FIG. 4 is a diagram showing an example structure of a document space of the document management server;

FIG. 5 is a diagram showing an example table for managing box attributes;

FIG. 6 is a diagram showing an example table for managing a notice destination address among the box attributes;

FIG. 7 is a diagram showing an example table for managing file attributes;

FIG. 8 is a flowchart showing an example procedure for a process of registering a notice destination mail address in a box;

FIG. 9 is a flowchart showing an example procedure for a process to be carried out by a user to register a document file in the document management server;

FIG. 10 is a diagram showing an example of a process instruction list screen;

FIG. 11 is a diagram explaining an outline of an example of a flow to provide a document in an exemplary embodiment;

FIG. 12 is a diagram showing an example of control information contained in a first URL;

FIG. 13 is a diagram showing an example content of a first mail;

FIG. 14 is a diagram showing an example content of a second mail;

FIG. 15 is a flowchart showing an example procedure for a process to be carried out by a document management server when storing a document;

FIG. 16 is a flowchart showing a part of an example procedure for a process to be carried out by the document management server when receiving a request using the first URL;

FIG. 17 is flowchart showing the remaining part of the example procedure for the process to be carried out by the document management server and a procedure for a process to be carried out by the same when receiving a request using a second URL;

FIG. 18 is a diagram showing an example transmission completion notice screen to be presented to the user after transmission of the second mail;

FIG. 19 is a diagram showing an example internal structure of a file access URL processing unit;

FIG. 20 is a flowchart showing an example procedure for a process to be carried out by a first URL processing unit when a method for protecting the second URL by means of a password is employed;

FIG. 21 is a flowchart showing an example procedure for a process to be carried out by a second URL processing unit when a method for protecting the second URL by means of a password is employed;

FIG. 22 is a diagram showing an example password setting screen for protecting the second URL;

FIG. 23 is diagram showing an example of a second mail to be sent to the user in the example shown in FIG. 20;

FIG. 24 is a flowchart showing an example procedure for a modified example of the process shown in FIG. 20;

FIG. 25 is a flowchart showing an example procedure for a modified example of the process shown in FIG. 21; and

FIG. 26 is a diagram showing an example hardware structure of a computer.

### DETAILED DESCRIPTION

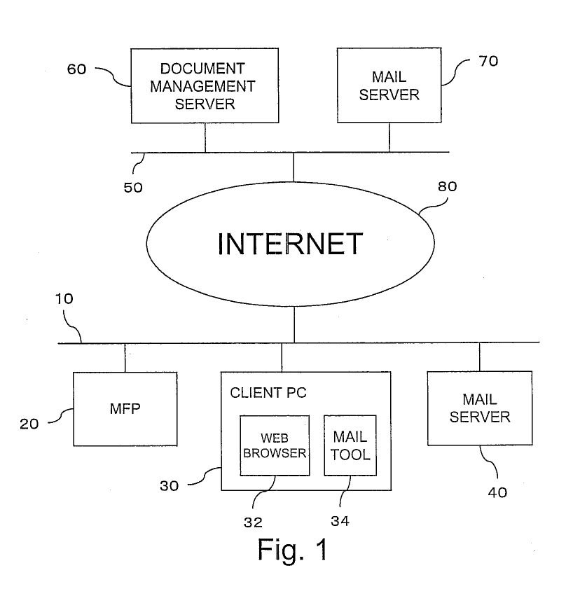

Initially, with reference to FIG. 1, there will be described an example document management system to which a method according to this embodiment can be applied.

This system comprises an MFP (Multifunction Peripheral) 20, a client PC (personal computer) 30, and a mail server 40, all of which are connected to a LAN (local area network) 10 on a user side, and a document management server 60 and a mail server 70, both of which are connected to a LAN 50 on a server side. The MFP 20, the client PC (personal computer) 30, and the mail server 40 are connected to the Internet 80 via the LAN 10, and the document management server 60 and the mail server 70 are connected to the Internet 80 via the LAN 50.

The document management server 60 is a computer system for storing a document file registered therein and providing the user with the document file.

The MFP 20 is a so-called digital multifunction peripheral device, and may comprise at least one of the scan, copy, print, and facsimile functions. The MFP 20 additionally has a function to connect to a network, such as a LAN, or the like, and a function to utilize a web service provided on the network. The MFP 20 can receive a service from the document management server 60 via the network. The MFP 20 can register, for example, the file of a document which is read by means of the scan function in the document management server 60.

The client PC 30 has a web (that is, World Wide Web) browser 32 and a mail tool (that is, a mail client-program) 34. The user can receive a service provided by the document management server 60, by means of the web browser 32 and the mail tool 34.

The client PC 30 can transmit and receive an electronic mail via the mail server 40 connected to the LAN 10.

The MFP 20 and the client PC 30 are examples of a client which receives a service provided by the document management server 60. Any device other than a PC or an MFP may be a client of the document management server 60. It should be noted that presentation of one MFP 20 and one client PC 30 in FIG. 1 is only for the purpose of illustration of examples, and that document management server 60 may have additional clients. Obviously, not all the clients are necessarily connected to the same LAN 10. The MFP 20 may transmit and receive an electronic mail via a mail server 40 on the Internet 80, rather than the mail server 40 on the LAN 10 to which the MFP 20 itself is connected.

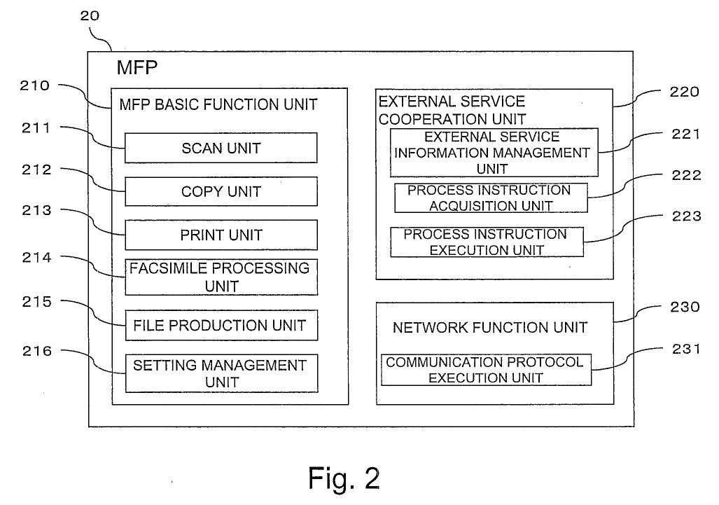

In the following, with reference to FIG. 2, details of an example functional structure of the MFP 20 will be described. The MFP 20 comprises, for example, an MFP basic function unit 210, an external service cooperation unit 220, and a network function unit 230.

The MFP basic function unit 210 comprises a scan unit 211, a copy unit 212, a print unit 213, a facsimile processing unit 214, a file production unit 215, and a setting management unit 216. The scan unit 211 is a device for optically reading a draft image on a sheet medium, such as paper, or the like, to produce electronic image data. The print unit 213 is a device for printing the image data on a sheet medium. The copy unit 212 is a functional portion for copying the draft image on a sheet medium to another sheet medium. The function of the copy unit 212 may be realized by supplying the image data of the draft, read by means of the scan unit 211, to the print unit 213 and printing the image data, by means of the print unit 213. The facsimile processing unit 214 is a device for transmitting and receiving a facsimile. For example, the facsimile processing unit 214 sends the image data of a draft, read by means of the scan unit 211, to a destination. The facsimile processing unit 214 additionally receives a facsimile image sent via a telephone line, sends the received facsimile image to the print unit 213 for printing, or accumulates the same in a memory device. The file production unit 215 produces an image file in a designated file format on the basis of the draft image read by means of the scan unit 211. The file production unit 215 can handle one or more file formats, including, for example, PDF (Portable Document Format), Ductworks (registered trademark) format, developed by Fuji Xerox Co., Ltd., and so forth, and produces an image file in a file format explicitly designated by the user or set as a default format. The setting management unit 216 manages the values of various setting items concerning operations of the respective units, including the scan unit 211, the copy unit 212, the print unit 213, the facsimile processing unit 214, the file production unit 215, and so forth. The setting management unit 216 receives setting values in relation to each of the setting items from the administrator or a general user of the MFP 20. The respective units, including the scan unit 211, or the like, operate with reference to the values set in the setting management unit 216.

The network function unit 230 is a device for communicating with other devices via a data communication network, such as a LAN, the Internet, or the like. The network function unit 230 has hardware for data communication, such as a communication interface circuit, or the like. The network function unit 230 additionally has a communication protocol execution unit 231. The communication protocol execution unit 231 carries out protocols for data communication. Communication protocols to be executed by the communication protocol execution unit 231 may include, for example, a network crisis management protocol, such as an SNMP (Simple Network Management Protocol), or the like; a print protocol, such as an LPD (Line Printer Daemon), or the like, for receiving a print instruction from a computer; a protocol for processing in response to a scan instruction sent from a computer; and so forth. The communication protocol execution unit 231 additionally carries out a protocol, such as a SOAP (Simple Object Access Protocol), or the like, for utilizing a web service.

The external service cooperation unit 220 carries out a process for utilizing an external service provided on a LAN and/or the Internet 80. The external service is a processing service provided by a server connected on the network, and may be realized as a web service. Use of an external service makes it possible to provide the user operating the MFP 20 with information processing service which is not available with the MFP 20 of concern. For example, using an external service, the MFP 20 can provide image-processing and/or character recognition, or the like, with respect to a draft image read by the MFP 20. Further examples of an external service may include file format conversion, file registration in a database, and so forth.

The external service cooperation unit 220 controls execution of a cooperation process with reference to a process instruction. A cooperation process is a process to be realized by one or more services cooperating with one another. A process instruction is a file which describes definition information which defines a cooperation process. A process instruction describes respective services which together constitute one cooperation process and information about the order in which to execute the respective services. In a process instruction, each of the services is expressed by means of identification information for uniquely specifying the service. As such identification information, access information (for example, a URL (Uniform Resource Locator)) for use in accessing a service may be used, as well as an identification number uniquely assigned according to a predetermined rule. The order in which to execute the respective services in a cooperation process may include condition branch and/or repetition, and so forth. In a process instruction, a process parameter concerning the entirety of the cooperation process, as well as a process parameter concerning an individual service, can be described. For example, for electronic mail transmission service, a transmission destination of an electronic mail can be one of the process parameters. A process instruction can describe such a cooperation process that a server A (not shown) on the Internet 80 carries out character recognition of a draft image read by the MFP 20, and then sends to a predetermined destination a file which contains the draft image and the result of the character recognition thereof. It should be noted that Japanese Patent Laid-open Publication No. 2004-288112 (or US-2004-0194108-A1), for example, which describes one example of a cooperation process based on a process instruction, is available for reference.

In the external service cooperation unit 220, an external service information management unit 221 holds attribute information for every external service, such as access information (for example, a URL) for accessing an external service.

A process instruction acquisition unit 222 obtains a list of a process instruction from the document management server 60 connected to the LAN or the Internet 80, and presents the same to the user. In this example, the document management server 60 provides various process instructions usable by the MFP 20. A user operating the MFP 20 obtains the list from the document management server 60, and selects his/her desired process instruction from the list. The process instruction acquisition unit 222 sends information about the user selection to the MFP 20. The MFP 20 in turn sends the selected process instruction to the process instruction acquisition unit 222. The document management server 60 can be realized as a web service. In this case, the process instruction acquisition unit 222 acquires the list and the process instruction, by means of the web service access protocol of the communication protocol execution unit 231.

A process instruction execution unit 223 interprets the process instruction acquired by the process instruction acquisition unit 222 in response to the user instruction or the process instruction selected by the user from among those which are registered in advance in the MFP 20, and calls for the services described in the file in order, to thereby realize a cooperation process.

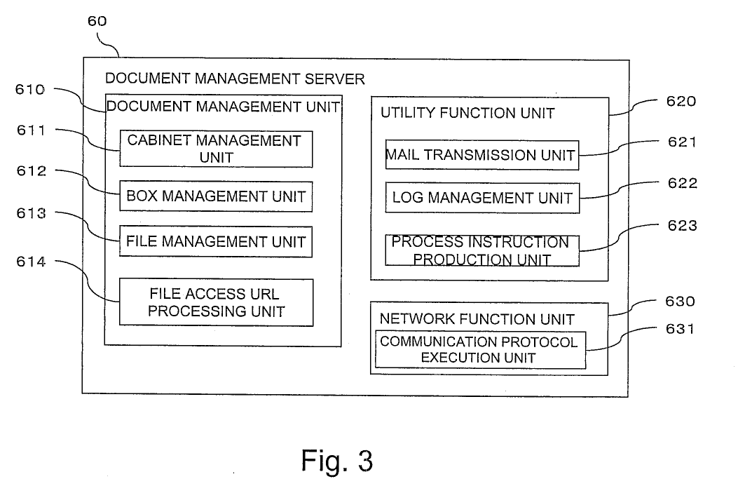

With reference to FIG. 3, details of an example functional structure of the document management server 60 will be described. The document management server 60 comprises a function to register a document file and a function to distribute a registered document file to a designated notice destination. The distribution function is basically realized by sending to a notice destination an electronic mail (hereinafter referred to as a “notice mail”) which contains access information (for example, URL) for accessing the document file stored in the document management server 60. Specifically, when the user having received the electronic mail accesses the document management server 60, by means of the received access information, the document management server 60 specifies the target document file on the basis of the information sent from the user accessing, and provides the file to the user. Here, in this embodiment, the possibility that any person other than the authentic person at the notice destination obtains the document file is reduced by sending a notice mail in a two-step manner (a two-step notice mail). Details of a document distribution process using a two-step notice mail will be described later. Before the description, the document management server 60 will be outlined.

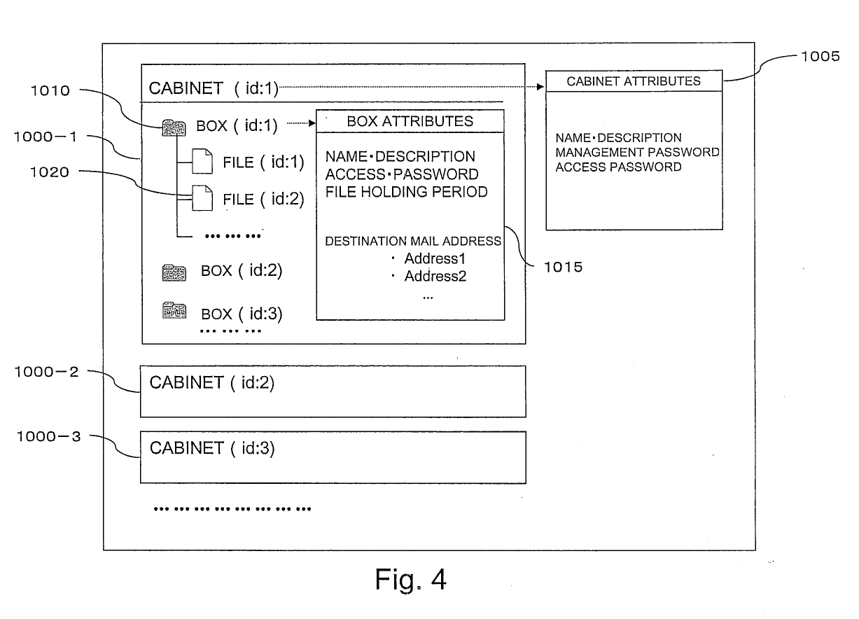

The document management server 60 in this example provides a document space referred to as a “cabinet” 1000-1, 2, 3, . . . (hereinafter collectively referred to as cabinet 1000), as shown in FIG. 4. One cabinet 1000 is allocated to one user group. A unique cabinet ID (identification information) is assigned to each cabinet 1000. Also, cabinet attributes 1005 are made in correspondence to each cabinet 1000. The cabinet attributes 1005 include a name and description of the cabinet for showing on the screen, a management password necessary for using a management function of the cabinet, an access password necessary for accessing the cabinet, and so forth.

In the cabinet, one or more boxes 1010 can be set. The box 1010 corresponds to a folder or a directory in a typical file system. The administrator or user of the cabinet 1000 can produce a box 1010 depending on the purpose, and register a document file 1020 in the produced box 1010. A unique box ID is assigned to each box 1010, to which box attributes 1015 are also given. The box attributes 1015 include the name and description of the box for showing on the screen, an access password necessary for accessing the box, and a holding period for holding a document file registered in the box 1010. The box attributes 1015 additionally include a list of a destination mail address to which a notice mail should be sent when a document file is registered in the box 1010.

Returning to FIG. 3, a document management unit 610 of the document management server 60 manages the document space, shown in FIG. 4. In the document management unit 610, a cabinet management unit 611 manages cabinets; a box management unit 612 manages boxes; and a file management unit 613 manages files.

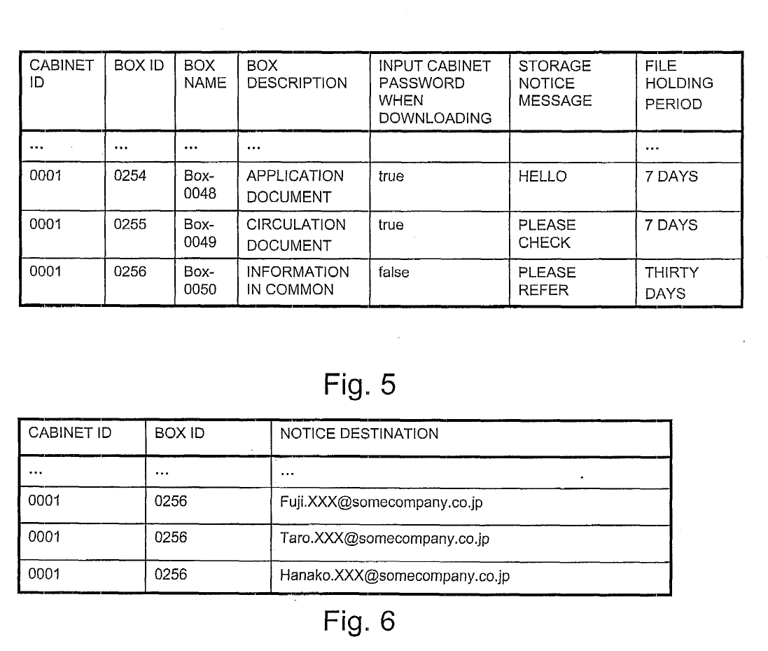

FIGS. 5 and 6 show an example data content of box attributes to be managed by the box management unit 612. In the table shown as an example in FIGS. 5 and 6, each row corresponds to one box. As shown in FIG. 5, the box attributes include respective pieces of information, including the cabinet ID of the cabinet to which the box belongs, the box ID of the box itself, the box name, the box description, information specifying whether or not a password of the cabinet is requested when user downloads the document registered in the box, a storage notice message to be described in a notice mail, and a holding period for holding a file registered in the box. As shown in FIG. 6, the electronic mail address of a notice destination to which a notice mail is to be sent when a document file is registered in the box is registered in the manner of being associated with the box ID of the box and the cabinet ID of the cabinet to which the box belongs.

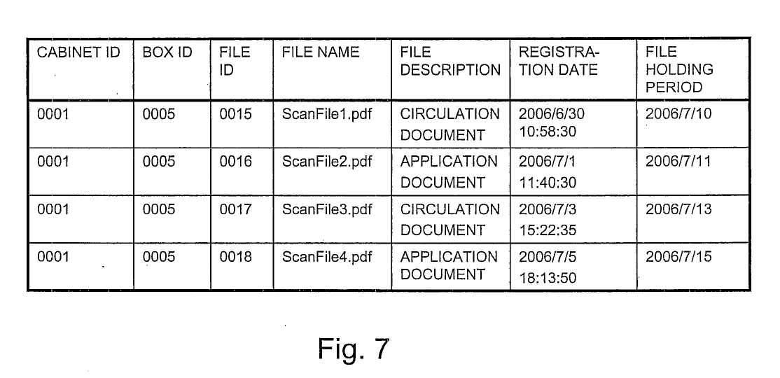

One example of the file attributes to be managed by the file management unit 613 is shown in FIG. 7. As shown in FIG. 7, the file attributes include the respective pieces of information, including the cabinet ID of the cabinet to which the file belongs, the box ID of the box to which the file belongs, the file ID of the file, the file name, a description associated with the file, the registration time and date of the file, and a holding period of the file.

A file access URL processing unit 614 produces a URL to be contained in a notice mail to be sent to the user. The file access URL processing unit 614 analyzes the information sent from the user accessing the document management server 60 by means of the URL contained in the notice mail, and, from the result of the analysis, determines whether or not to provide the document file to the user. Details of this process will be described later.

A utility function unit 620 is a device of the document management server 60 for executing various processes associated with a process to be carried out by the document management unit 610. A mail transmission unit 621 in the utility function unit 620 sends a notice mail. A log management unit 622 records log information, including a user operation carried out in relation to the document management server 60 (for example, registration of a document file, download of a document file, or the like), error occurrence, and so forth. A process instruction production unit 623, in response to a request from the MFP 20, produces a process instruction which shows a process utilizing various services provided by the document management server 60, and presents the same to the MFP 20.

A network function unit 630 is a device of the document management server 60 for communicating with other devices via a data communication network, such as a LAN, the Internet, or the like. A communication protocol execution unit 631 in the network function unit 630 executes a data communication protocol, such as SNMP, SOAP, or the like.

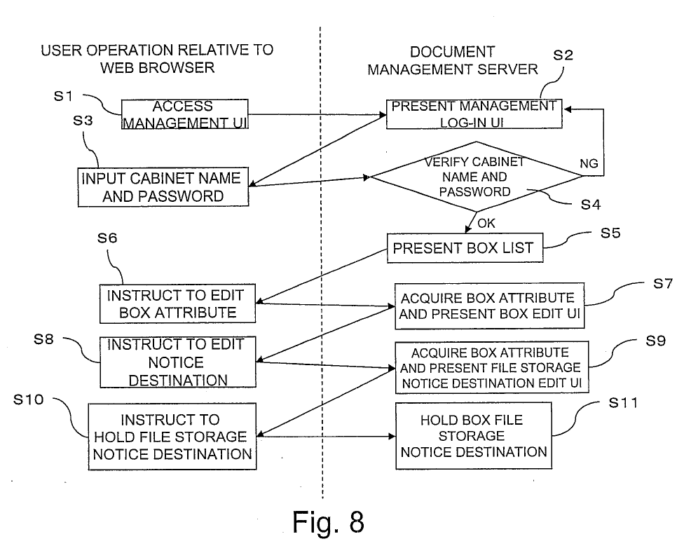

In the following, with reference to FIG. 8, there will be described an example flow of a process of registering, by the administrator, a destination of a notice mail to be sent when a document file is registered, in the document management server 60.

The administrator operates the web browser 32 of the client PC 30 to access the web page of the management UI (user interface) of the document management server 60 (S1), and the document management server 60 thereupon provides the web page to the web browser 32 (S2). On the web page, an administrator log-in UI for inputting a cabinet name, an access password for accessing the cabinet, and so forth, are shown. When the administrator inputs the cabinet name and the password in the UI via the web browser 32 (S3), the document management server 60 determines whether or not the input password is the correct password corresponding to the cabinet name (S4). When the password is incorrect, the process returns to step S2. On the other hand, when the password is correct, a web page which shows the list of the boxes contained in the cabinet corresponding to the cabinet name is provided to the web browser 32 (S5).

When the administrator selects a box to edit from the list shown in the web browser 32 (S6), the web browser 32 sends the selection information to the document management server 60. The document management server 60 then obtains the box attribute of the selected box from the box management unit 612, produces a web page which shows a box edition UI screen, and sends the same to the web browser 32 (S7). On the web page, the box attribute items are listed, so that an target item to be edited can be selected from the listed items. When the administrator selects, for example, edition of a notice destination in the list (S8), the document management server 60, in response to the selection instruction, obtains the list of the destination mail addresses registered as the box attribute from the box management unit 612, produces a web page of a notice destination edition UI, which shows the list, and sends the same to the web browser 32 (S9). When the administrator edits, by means of the notice destination edition UI, by adding, deleting, or modifying the electronic mail address of a destination, or the like, and instructs registration, the result of edition is sent from the web browser 32 to the document management server 60 (S10). The document management server 60 then registers in the box management unit 612 the notice destination list resulting from the edition (S11).

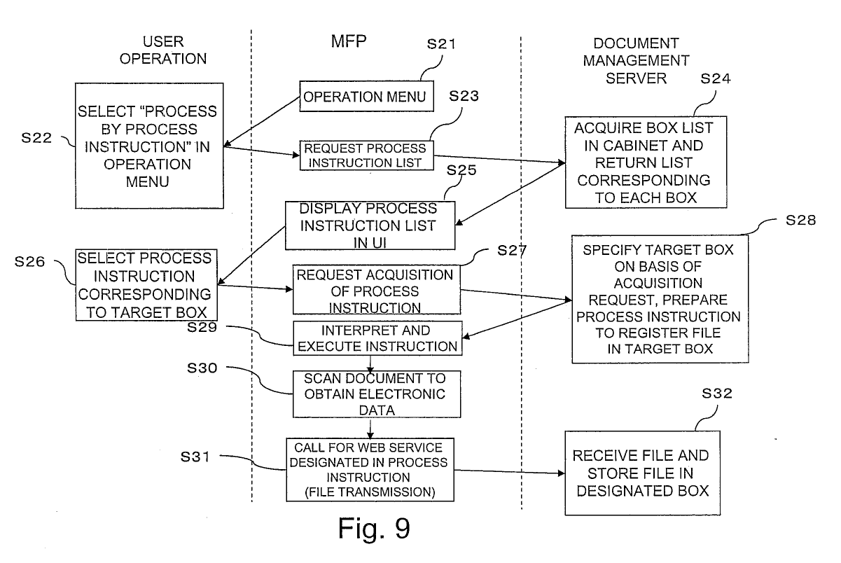

In the following, with reference to FIG. 9, there will be described an example flow of a process in which the user registers a target document file to be distributed in the document management server 60. Specifically, there will be described an example in which the user scans a paper document, by means of the MFP 20, and registers the same.

In this procedure, the MFP 20 causes to display an operation menu on the UI screen equipped with a liquid crystal touch panel, or the like (S21). Then, when the user selects an operation item “document registration” on the operation menu (S22), the process instruction acquisition unit 222 of the MFP 20 requests the document management server 60 to send a process instruction list (S23). Here, in the MFP 20, additional information, such as the address of the document management server 60, a password necessary for accessing a specific cabinet, and so forth, are set in advance. Therefore, in step S23, the process instruction acquisition unit 222 requests the document management server 60, by means of the additional information, to send a process instruction list corresponding to the concerned cabinet. The requested process instruction list is a list of process instructions each of which describes a process to be carried out for registering a document in each of the boxes available in the cabinet.

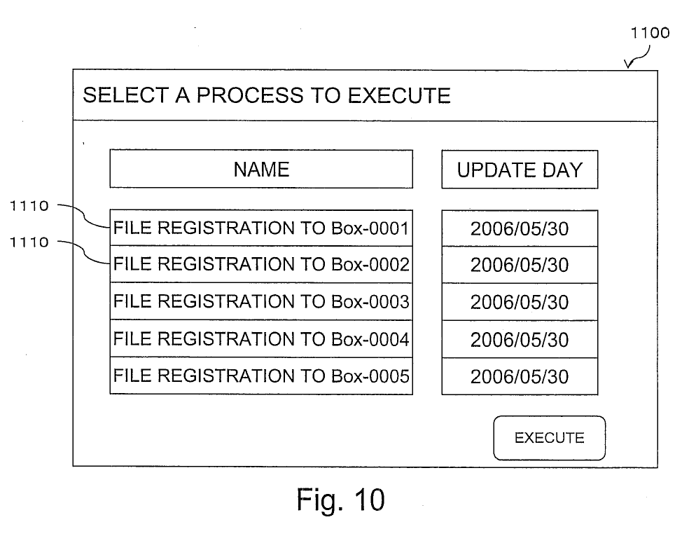

In response to this request, the document management server 60 obtains the list of boxes available in the cabinet of concern, produces a process instruction list which contains menu items corresponding to each of the boxes included in the list, and sends the same to the MFP 20 (S24). The MFP 20 displays the process instruction list on the screen (S25). An example of a process instruction list screen 1100 to be then shown is shown in FIG. 10. On the screen 1100, document file registration buttons 1110 corresponding to the respective boxes available in the cabinet are shown in the form of a list. Each of the buttons 1110 has information corresponding thereto for requesting a process instruction for registering a document file in a corresponding box. Information on the last update date of each box is also shown. When the user selects on the screen the button of the box in which a document file is to be registered to thereby instruct execution of the concerned process (S26), the process instruction acquisition unit 222 of the MFP 20 requests the document management server 60 to send a process instruction in relation to the box corresponding to the selected button (S27).

The document management server 60 specifies the target box by reference to the request, produces a process instruction to register a document file in the target box, and sends the same to the MFP 20 (S28). The process instruction execution unit 223 of the MFP 20 interprets and executes the process instruction (S29). With the process instruction executed, the scan unit 211 scans a draft document set on a document feeder (not shown) of the MFP 20, and the file production unit 215 stores the image data of the scanning result in the file (S30). Then, the process instruction execution unit 223 calls for a file transmission web service designated by the process instruction, and forwards the produced document file of the scanning result to the web service, requesting storage in the box designated in the document management server 60 (S31). This web service may be provided by, for example, the document management server 60. In response to the process executed by the web service, the document management server 60 stores the document file in the designated box (S32).

In the above, a case in which the file of a document scanned by the MFP 20 is registered in the document management server 60 is described. In the case where the user wishes to register in the document management server 60 a document file in the client file PC 30, a web page, rather than a process instruction, provided by the document management server 60 is used as a UI in carrying out a similar procedure.

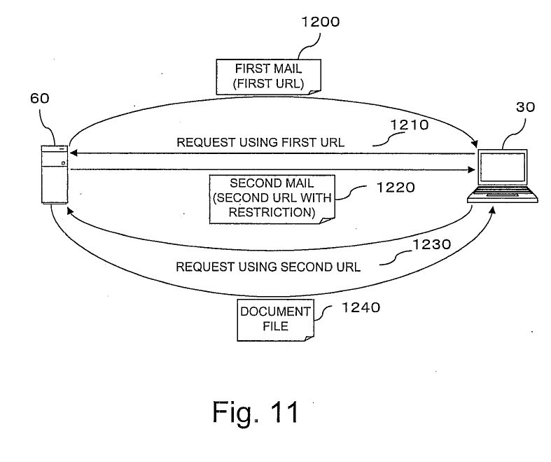

Upon completion of storage of a document file in the box in response to a user instruction, as described above, the document management server 60 sends a notice mail for document distribution to the notice destination mail address set on the box. Here, in this embodiment, the document management server 60 controls document distribution, by means of a two-step notice mail. An example of this flow will be outlined with reference to FIG. 11.

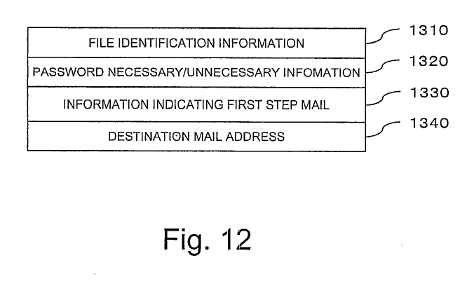

In this flow, after storage of a document file in the box, the document management server 60 sends a first mail 1200 of the two-step mail to the mail address of the notice destination. The first mail 1200 contains a first URL. The first URL contains, for example, control information, such as that shown in FIG. 12; that is, for example, file identification information 1310 for specifying a target document file, password necessary/unnecessary information 1320 indicating whether or not a password word/words of the cabinet and/or box is/are necessary when making a request, information 1330 indicating that the concerned notice mail is a first-step mail, and the mail address 1340 of a destination to which the notice mail is sent. It should be noted that, in the case where whether the concerned notice mail is a first or second-step mail is described in a portion other than the control information, such as, for example, the portion of path information, the information 1330 is unnecessary. Also, in a system without protection using a cabinet and/or box password/passwords, the password necessary/unnecessary information 1320 is unnecessary. The control information as described above may be contained, for example, in the first URL as a query string.

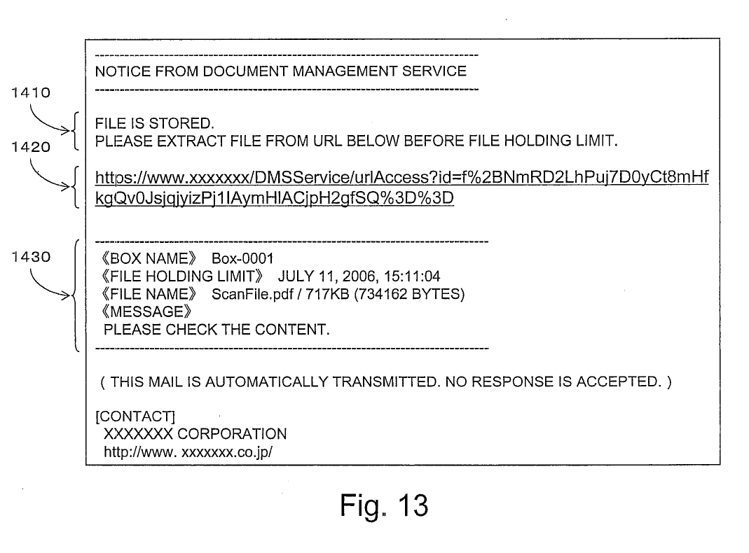

FIG. 13 shows a specific example of the first mail 1200. In this example, the first mail 1200 contains a first mail fixed message 1410, a first URL 1420, and related information 1430 of the document file. The first mail fixed message 1410 may be a message, for example, indicating completion of registration of the document file. The related information 1430 may contain the name of the box in which the document file is registered, a holding period, the file name, the file size, and a storage notice message. The related information is produced by reference to the box attribute, shown in FIG. 5, and the attribute information of the file, shown in FIG. 7. In the character string of the first URL 1420, “https://www.xxxxxxx” indicates the host name of the document management server 60, and “/DMSService/URLAccess” indicates a path for calling for a process among those to be carried out by the first access URL processing unit 614 in connection with the first URL. The subsequent portion; namely, “?id=” and thereafter, is a query character string representing the control information, shown in FIG. 12. In the example shown in FIG. 13, the character string of the control information is encrypted.

Returning to FIG. 11, the user at the notice destination reviews the first mail 1200, by means of the mail tool 34 of his/her client PC 30, and accesses the first URL, by means of the web browser 32. In response to this operation, the web browser 32 sends to the document management server 60 a request 1210 which contains the host name, path, and query character string in the first URL. Having received this request 1210, the file access URL processing unit 614 of the document management server 60 carries out a process in relation to the first URL, by reference to the information about the path in the request.

In this process, the file access URL processing unit 614 produces a second mail 1220, or a notice mail of the second step, and sends the same to the same destination mail address. The notice destination mail address can be obtained by analyzing the query character string contained in the request 1210. The second mail 1220 contains a second URL. The second URL contains the host name and path for specifying the processing unit 614 of the document management server 60 and control information. The control information contains, for example, file identification information for specifying a target document file. The control information is described, for example, in the form of a query character string. The file identification information to be contained in the control information of the second URL may be produced by reference to the file identification information contained in the request 1210. The control information may contain information indicating that the concerned mail is a second mail.

Restriction conditions may be set on the second URL. An example restriction condition may be a validity limit. That is, access by means of the second URL is admitted only when the access is made before expiration of the validity limit. Generally, in view that the first mail 1200 is sent when a person different from the user at the notice destination stores a document file, there is no certainty that the user at the notice destination is aware of the first mail 1200. Therefore, there may be a case where the user in the notice destination cannot obtain the document file when a short validity limit is set on the first URL of the first mail 1200. However, in view that the second mail 1220 is sent after the user reads the first mail 1200 and applies a process for obtaining the document file, the user knows that a second mail 1220 will arrive shortly after the operation. Therefore, even when a validity period is set on the second URL, the authentic user at the notice destination can generally obtain the document file without a problem before the validity limit. The information about the validity limit may be, for example, contained as a part of the control information in the second URL.

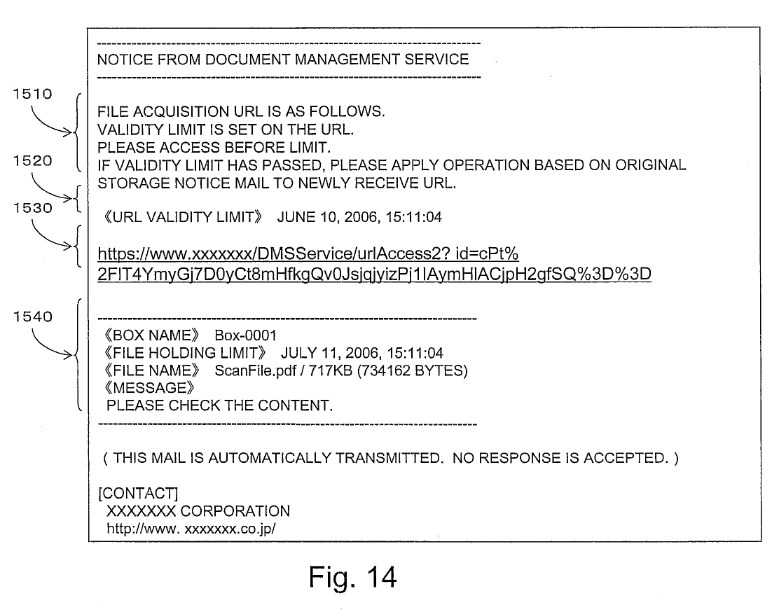

FIG. 14 shows a specific example of the second mail 1220. In this example, the second mail 1220 contains a second mail fixed message 1510, second URL validity limit information 1520, a second URL 1530, and related information 1540 of the document file. The second mail fixed message 1510 is a message, for example, which describes that the mail of concern is a second mail and that the URL shown in the mail of concern is subjected to a validity limit. The message 1510 may additionally include a description to the effect that, should the validity limit set on the second URL reach its expiration, the document file can be obtained by accessing the document management server 60, by means of the first URL of the original storage notice mail (the first mail). Similar to the first URL, the second URL 1530 contains the host name of the document management server 60, in which the subsequent path; namely, “/DMSService/URLAccess2”, is a path for calling for a process relevant to the second URL among those processes to be carried out by the file access URL processing unit 614. The control information subsequent to the path is encrypted. The related information 1540 may be the same as the related information 1430 of the first mail 1200.

Returning to FIG. 11, the user having received this second mail 1220 reviews the second mail 1220, using the mail tool 34 of his/her client PC, and accesses the second URL contained therein, using the web browser 32. In response to this operation, the web browser 32 sends to the document management server 60 a request 1230 which contains the host name, path, and query character string in the second URL. Having received this request 1230, the file access URL processing unit 614 of the document management server 60 carries out a process relevant to the second URL on the basis of the information about the path contained in the request 1230. In this process, the file access URL processing unit 614 analyzes the query character string to obtain the validity limit and the file identification information. Then, when the current time is before the validity limit, the document file 1240 corresponding to the file identification information is extracted from the file management unit 613 and sent to the client PC 30.

According to the method shown in FIG. 11, even when a third party knows the first URL in the first mail and requests the document management server 60 to send the document file, by means of the known first URL, in response to the request the second mail is sent to the authentic user at the notice destination of the first mail. Because the document file cannot be obtained without use of the second URL in the second mail, a third party who should obtain, by any means, the first URL still cannot obtain the document file, by means of only the first URL. Further, should a third party obtain the second URL by any means, because a validity limit is set on the second URL, the possibility that the third party can obtain the document file is low.

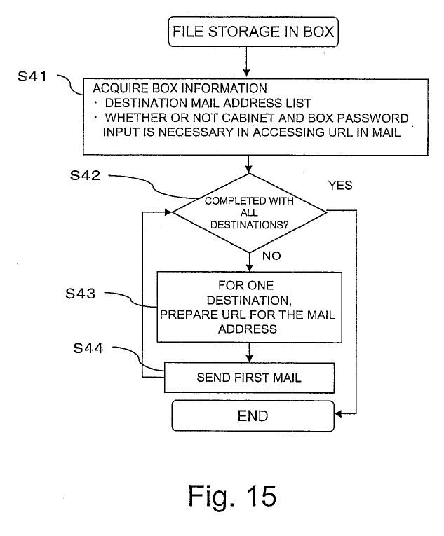

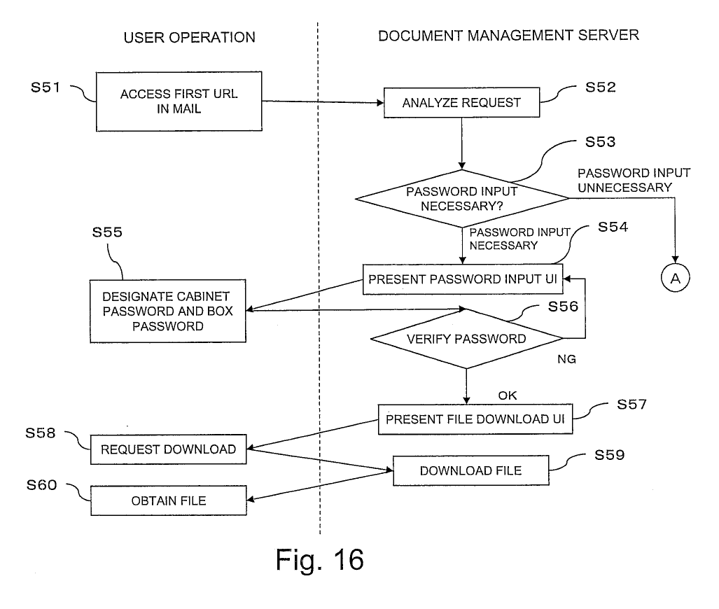

A procedure for a process to be carried out by the document management server 60 in the flow of the process shown in FIG. 11 will be described in further detail. Initially, with reference to FIG. 15, there will be described an example of a procedure for a process to be carried out after storage of a document file in a box is completed. When a document file is stored in the box at the step S32 as described above, the file access URL processing unit 614 of the document management server 60 obtains the list of destination mail addresses, information indicating whether or not an access password of the cabinet is necessary when downloading the document file, and information indicating whether or not an access password of the box is necessary, among the attribute information of the box, which is managed by the box management unit 612. Then, as for the respective destination mail addresses in the list, the processes in steps S43 and S44 are repetitively applied (via S42). Specifically, in step S43, one of the mail addresses to which the first mail is yet to be sent is extracted from the list of the destination mail addresses. Then, a first URL for that mail address is prepared, and a first mail containing that first URL is produced. Then, the first mail is sent to the destination mail address, by means of the mail transmission unit 621 (S44). It should be noted that the process in steps S43 and S44 may be carried out in relation to a destination mail address designated by the user having instructed storage of the document file, instead of, or in addition to, the destination mail address set in the box.

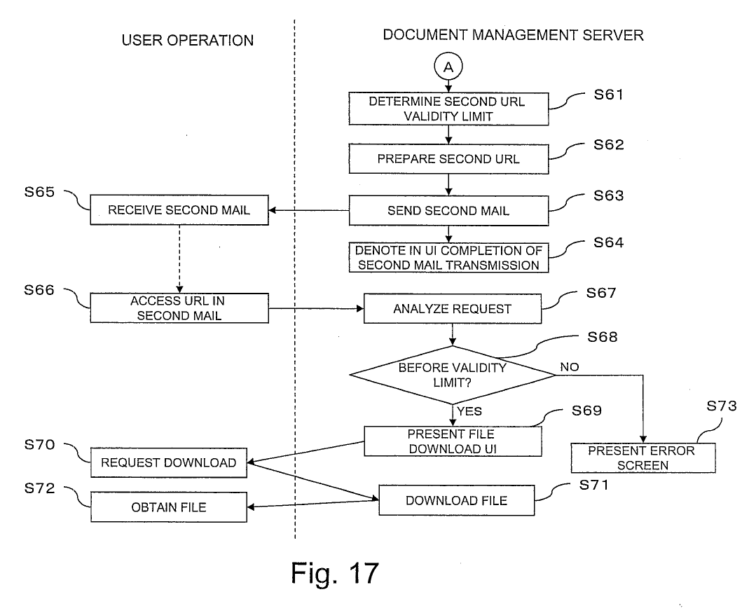

With reference to FIGS. 16 and 17, there will be described an example of a procedure for a process to be carried out by the file access URL processing unit 614 of the document management server 60 upon receipt of a request which is made by use of the URL included in the mail. As described above, the file access URL processing unit 614 has a function to carry out a process to handle an access which is made by means of the first URL and a function to carry out a process to handle an access which is made by means of the second URL, and these functions are discriminated by the path of the URL used in the access.

As shown in FIG. 16, initially, the user carries out an operation to access the first URL contained in the first mail, using the client PC 30 (S51), and the document management server 60 receives the HTTP (Hypertext Transfer Protocol) request which is sent by the web browser 32 in response to the operation. In view that the path information in the request indicates a function corresponding to the first URL among the functions of the file access URL processing unit 614, the function corresponding to the first URL is called for. This function analyzes the request (S52) to determine whether or not the request of concern requires password input (S53). In the analysis in step S52, the query character string contained in the request is decoded, and information about each of the items is obtained from the result of decoding.

The example shown in FIG. 16 is a case in which either of a method using passwords of a cabinet and a box, and a method using a two-step mail, as shown in FIG. 11, is selectively used as a method for protecting a document file. A protection method using cabinet and box passwords can be used in providing a document file to a user who knows the cabinet and box passwords. Meanwhile, when a file protection method, as shown in FIG. 11, which does not use cabinet and box passwords is employed, a document file can be provided to a user who does not know the cabinet and box passwords. Which of the methods to be selected may be set as the attribute of a box in which the document file is registered. Alternatively, the user may designate which of the protection methods is used, when registering the document file in the document management server 60.

The determination in step S53 is made on the basis of, for example, the password necessary/unnecessary information (see FIG. 12) contained in the request. When it is determined in step S53 that password input is necessary, the document management server 60 produces a web page which shows a password input UI screen, and sends the same to the client PC 30 having made the request (S54). When the user inputs passwords to access the cabinet and the box in the password input UI shown by the web browser 32 (S55), the data on the passwords are sent to the document management server 60. The document management server 60 compares the received passwords with the passwords of the cabinet and the box where the requested document file is stored (S56). When the result of comparison shows that the input passwords are not correct, the process returns to step S54, where the user is prompted to input the passwords again. On the other hand, when the result of comparison shows that the input passwords are correct, the file access URL processing unit 614 produces a web page which shows a UI screen for downloading a document file, and sends the same to the client PC 30 (S57).

The UI screen is a UI screen for determining whether or not downloading of a document file is necessary, and shows attribute information, including, for example, the file name of an target document file, the names of the box and cabinet to which the file belongs, and so forth, and also a UI component (for example, a button) for instructing whether or not downloading is necessary. When the user checks the UI screen shown in the web browser 32 and inputs an instruction to download (S58), the document management server 60 carries out a process to download the target document file to the client PC 30 (S59). The user obtains the downloaded document file (S60). It should be noted that, when a correct password is input in step S56, the document management server 60 may instantly provide the target document file without carrying out the process to provide a UI for determining whether or not downloading is necessary (S57).

Meanwhile, when it is determined in step S53 that password input is unnecessary; that is, when a two-step mail protection method is employed, the process proceeds to the process shown in FIG. 17. In this process, initially, the file access URL processing unit 614 determined the validity limit of the second URL (S61). The validity limit of the second URL may be calculated by, for example, adding to the current time the validity period of the second URL, set in advance on the document management server 60. The validity period of the second URL is, for example, a few tens of seconds to a few hours; that is, very short as compared with the holding period of the document file. The length of the validity period of the second URL may be constant across the entirety of the document management server 60, or may be individually set for every cabinet or box. Alternatively, the person having registered a document file in the document management server 60 may designate the length of the validity period of the second URL corresponding to the document file. Still alternatively, the person having made the request using the first URL may designate the length of the validity period of the second URL to be issued corresponding to the request.

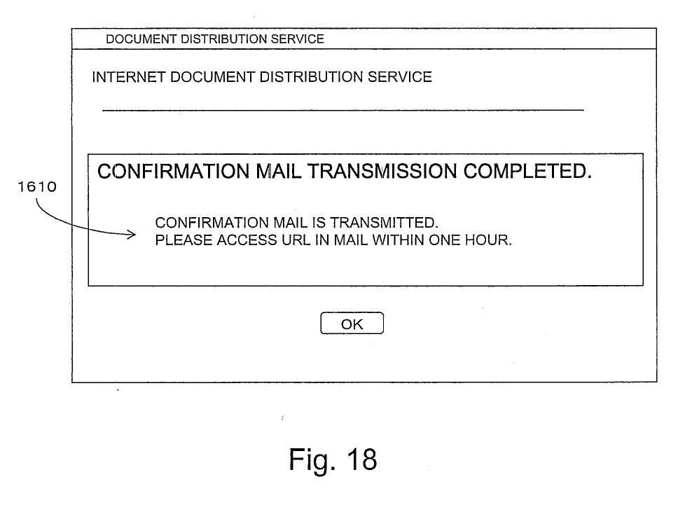

Thereafter, the file access URL processing unit 614 produces a second URL which contains the validity period determined in step S61 and the file identification information contained in the request (S62), and produces a second mail which contains the second URL. As the destination of the second mail, the destination mail address contained in the request is set. The file access URL processing unit 614 instructs the mail transmission unit 621 to send the second mail to the destination. When the mail transmission unit 621 sends the second mail, the file access URL processing unit 614 sends a UI screen which shows a description to the effect that the second mail has been sent to the client PC 30 having made the request (S64). On the UI screen, for example, as shown in FIG. 18, there is shown a message 1610 indicating that the second mail (in FIG. 18, referred to as a “confirmation mail”) has been sent and defining a valid period (one hour in the illustrated example) of the second URL. The user viewing the UI screen in the client PC 30 waits for the arrival of the second mail.

The user receives the second mail (S65), and instructs the web browser 32 to access the second URL contained in the second mail (S66). In response to the instruction, the web browser 32 produces an HTTP request corresponding to the second URL, and sends the same to the document management server 60. The document management server 60 having received the request calls for a function to process the second URL among those functions which are provided by the file access URL processing unit 614. This function analyzes the request (S67). In the analysis, the query character string contained in the request is decoded to obtain the file identification information and the information about the validity limit contained therein. Then, the file access URL processing unit 614 determines whether or not the current time is before the validity limit (S68), and, when it is before the validity limit, sends to the client PC 30 a web page which shows a document file download UI screen (S69). This UI screen may be similar to that provided in step S57.

When the user inputs an instruction to download on the UI screen shown in the web browser 32 (S70), the document management server 60 carries out a process to download the target document file to the client PC 30 (S71). The user obtains the downloaded document file (S72). Alternatively, when it is determined in step S68 that the current time is before the validity limit, the document management server 60 may instantly provide the target document file without carrying out step S69.

Meanwhile, when it is determined in step S68 that the current time is not before the validity limit, the file access URL processing unit 614 sends to the client PC 30 a web page which shows an error screen (S73). The error screen contains a message indicating, for example, that the validity limit of the second URL is expired. In addition, a description about a method for coping with an expired validity limit may be included in the error screen, suggesting that, for example, the document file can be obtained by accessing again the first URL contained in the original first mail and obtaining the second mail again.

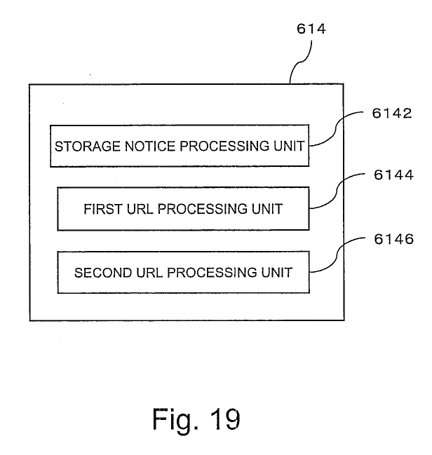

The processing service provided by the file access URL processing unit 614, as described above, can be classified, for example, into a storage notice processing unit 6142, a first URL processing unit 6144, and a second URL processing unit 6146, as shown in FIG. 19. The storage notice processing unit 6142 is responsible for carrying out notification when a document file is stored in the document management server 60, and carries out the process procedure shown in FIG. 15 in the above example. The first URL processing unit 6144 is responsible for carrying out a process to cope with a request which is made by means of the first URL, and carries out the process procedure shown in FIG. 16 in the above example and steps S61 to S64 in FIG. 17. The second URL processing unit 6146 is responsible for carrying out a process to cope with a request which is made by means of the second URL, and carries out steps S67 to S73 in the above example.

It should be noted that, although in the above description the validity limit set on the second URL is included in the second URL itself, the transmission time and date of the second mail may instead be included in the second URL and notified to the user. In this case, the document management server 60 obtains the transmission time and date from the request using the second URL, and calculates the second URL validity limit by adding to the obtained transmission time and date the validity period set as the attribute of the box or cabinet to which the target file belongs.

Also, in response to the request using the first URL, a UI screen for prompting input of the validity limit of the second URL may be sent, so that the user designates the validity limit of the second URL.

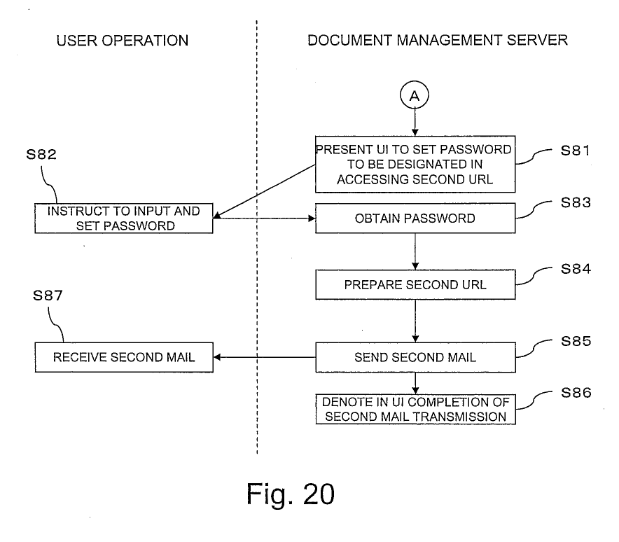

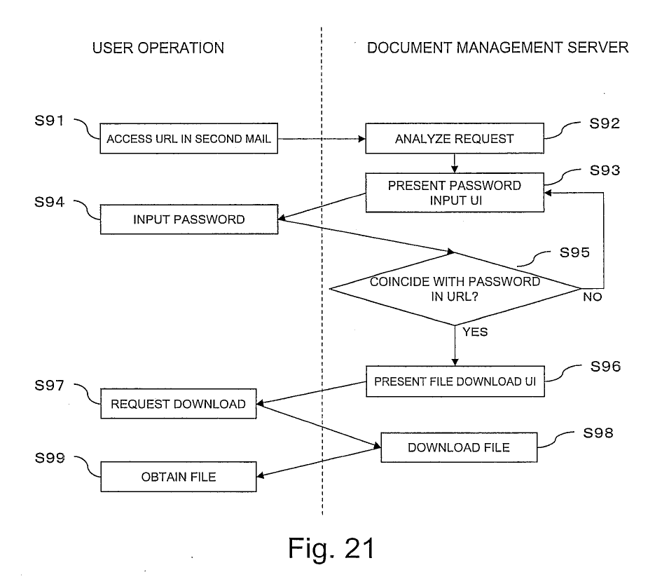

In the above description, an example in which a validity limit is set as restriction condition in relation to the second URL is described. However, the restriction condition to be set in relation to the second URL is not limited to the above. As another example, a password may be set as restriction condition in relation to the second URL. For example, the user having accessed the document management server 60 using the first URL may designate a password. In the process in this case, the process procedure shown in FIGS. 15 and 16 can be used as is. The process procedure shown in FIG. 17 replaces the process procedure shown in FIGS. 20 and 21. In the following, the procedure shown in FIGS. 20 and 21 will be described.

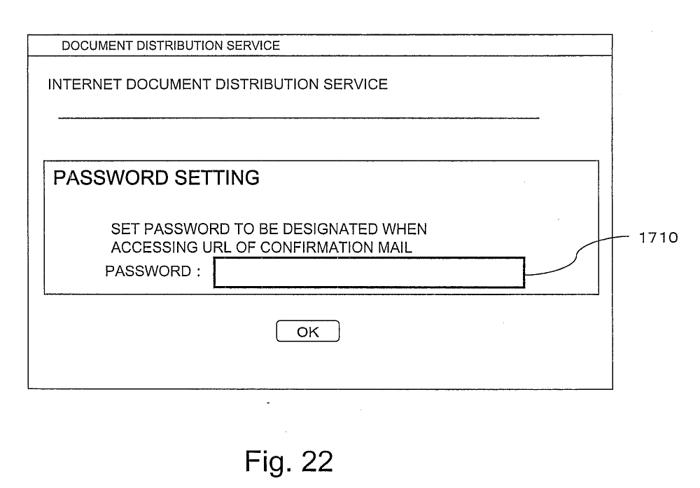

In this procedure, when it is determined in step S53 of the procedure shown in FIG. 16 that input of a password (of the cabinet and the box) is unnecessary, the first URL processing unit 6144 of the file access URL processing unit 614 sends to the client PC 30 a web page for designating a password to be input in an access using the second URL (S81). An example of display of the web page is shown in FIG. 22. On the web page, a message for prompting designation of a password and a password input column 1710 are shown.

When the user inputs a password on the web page shown by the web browser 32 (S82), the first URL processing unit 6144 obtains the password (S83), and produces a second URL which contains the password as one item of the control information (S84). Whereas a second URL which contains the information about the second URL validity limit is produced in step S62 in FIG. 17, a second URL which contains a password designated by the user, instead of the validity limit, is produced in step S84. It should be noted that, because a password designated by the user is encrypted and contained in the second URL, a third party cannot know the value of the password by just viewing it.

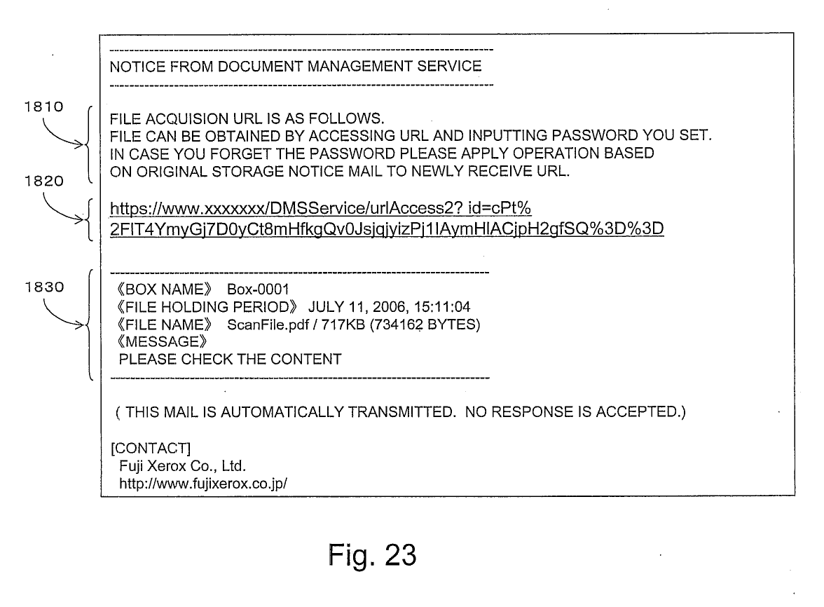

Then, the first URL processing unit 6144 produces a second mail which contains the second URL. An example of the description included in the second mail then produced is shown in FIG. 23. The description contains a second mail fixed message 1810, a second URL 1820, and related information 1830 thereof. The second mail fixed message 1810 describes, for example, that the mail of concern is a second mail, and that the password set by the user himself/herself needs to be input in an attempt to obtain the document by means of the URL shown in the mail of concern. The message 1810 may additionally include a description to the effect that, should the user forget the password he/she has set, the document file can be obtained by accessing again the document management server 60, by means of the first URL shown in the original storage notice mail (the first mail).

The first URL processing unit 6144 sends the produced second mail to the user having made the request (S85), and provides the client PC 30 with a UI screen which shows a description to the effect that the second mail has been transmitted (S86). The UI screen may be one such as that shown in FIG. 18, with the message concerning the validity period or limit not included as unnecessary, and a message alerting the user not to forget the designated password set in step S82 may be included instead.

Referring to FIG. 21, the user having received the second mail carries out an operation to access the second URL shown in the mail (S91), and in response the web browser 32 sends a request which contains the information about the second URL to the document management server 60. The management server 60 having received the requests calls for the second URL processing unit 6146. The second URL processing unit 6146 analyzes the request (S92), and obtains the value of a password corresponding to the second URL. Further, the second URL processing unit 6146 produces a web page for inputting a password, and sends the same to the client PC 30 having made the request (S93). When the user operates the web browser 32 to input a password on the web page (S94), the second URL processing unit 6146 having received the password determines whether or not the received password coincides with the password obtained from the request in step S92 (S95). When it is determined that the passwords do not coincide with each other, the process returns to step S93, and the web page for re-inputting a password is presented to the client PC 30. On the other hand, when it is determined in S95 that the passwords coincide with each other, the second URL processing unit 6146 sends to the client PC 30 the web page for downloading a document file (S96). When the user inputs a download instruction on the web page (S97), the target document file is sent to the client PC 30 (S98). With the above, the user obtains the document file indicated by the first mail (S99).

In the example shown in FIGS. 20 to 23, the user having made a request by means of the first URL is encouraged to set a password for acquiring a document by means of the second URL. However, the information to be set by the user is not limited to a password, and any information secret to the user may be usable. For example, instead of a password, a pair consisting of a question and an answer thereto may be set by the user. In this case, the document management server 60 having received a request by means of the second URL sends to the client PC 30 a UI screen which shows the question and a column for the answer thereto, and, when the answer filled by the user in the column is correct, provides the document file.

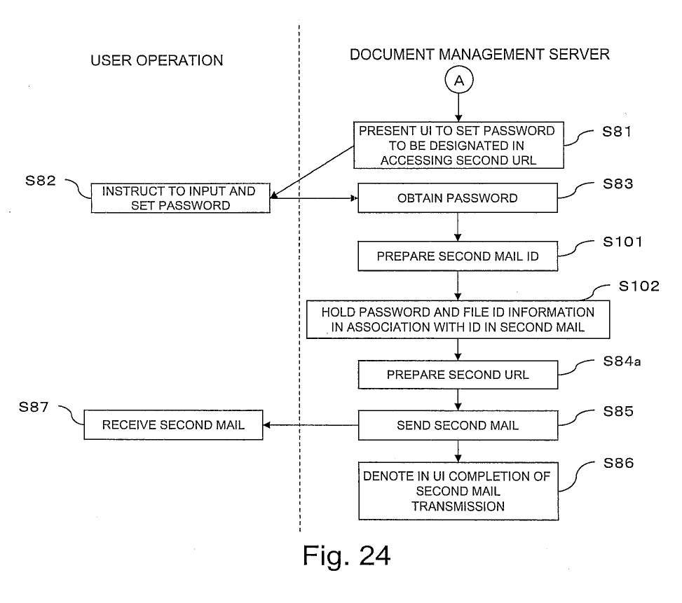

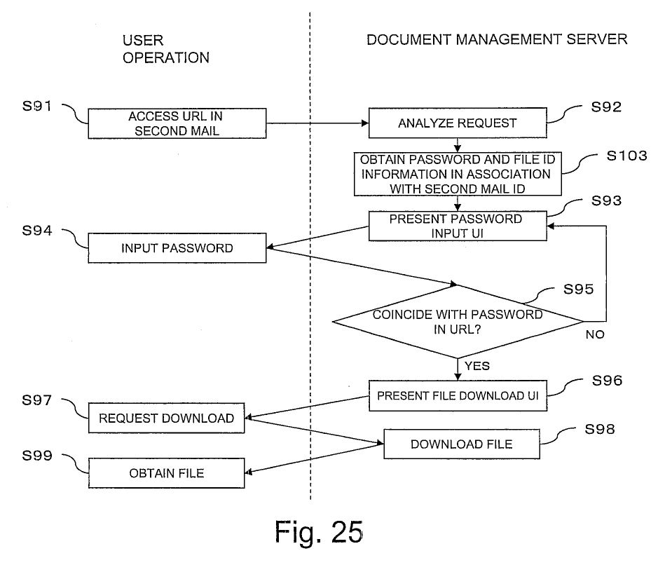

In the example described with reference to FIGS. 20 to 23, the file identification information and the password are encrypted before being contained in the second URL and notified to the user. As another example, a case in which the information is not contained in the second URL but is managed by the document management server 60 will be described with reference to FIGS. 24 and 25. One example of a procedure shown in FIGS. 24 and 25 corresponds to the procedure shown in FIGS. 20 and 21, in which steps in which processes identical with those of respective steps shown in FIGS. 20 and 21 are assigned the same reference numerals. It should be noted that, as a process procedure of the storage notice processing unit 6142 and the first URL processing unit 6144, the process shown in FIGS. 15 and 16 may be utilized as is.

In the procedure shown in FIG. 24, the first URL processing unit 6144 obtains a password from the client PC 30 in step S83, produces a unique ID (hereinafter referred to as a second mail ID) to be assigned to a second mail (S101), and stores, in a predetermined database, the password and the file identification information contained in the request obtained in step S52 (see FIG. 16) in association with the ID (S102). Then, the first URL processing unit 6144 produces a second URL which contains the second mail ID (S84a), instead of the file identification information and the password, and sends the second mail which contains the second URL (S85).

Thereafter, with reference to FIG. 25, when the user having received the second mail accesses the second URL included in the second mail (S91), the second URL processing unit 6146 analyzes the request from the user (S92) to obtain the second mail ID, and retrieves from the database the file identification information and a password associated with the second mail ID (S103). The subsequent process is similar to the procedure illustrated in FIG. 21.

In the example shown in FIGS. 24 and 25, instead of containing substantial control information, such as a password, file identification information, or the like, in the second URL, the substantial control information is stored in the document management server 60 in association with the second mail ID, and the second mail ID is contained in the second URL. A similar idea is applicable to the example illustrated in FIGS. 13 to 18, in which use of the second URL is limited by the validity limit, rather than a password. That is, in this case, file identification information and the validity limit information are stored in association with the second mail ID, and the second mail ID is contained in the second URL. Similarly, control information (see FIG. 12), such as file identification information, a destination mail address, and so forth, which is used in a process in relation to the first URL, is stored in association with the ID of the first mail, and the ID of the first mail, instead of the control information, may be contained in the first URL.

As another example, a validity limit and secret information, such as a password, or the like, may be both set on the second URL as restriction conditions. In this case, the document management server 60 provides a document file only when the request using the second URL is made before the validity limit and the user correctly inputs the secret information.

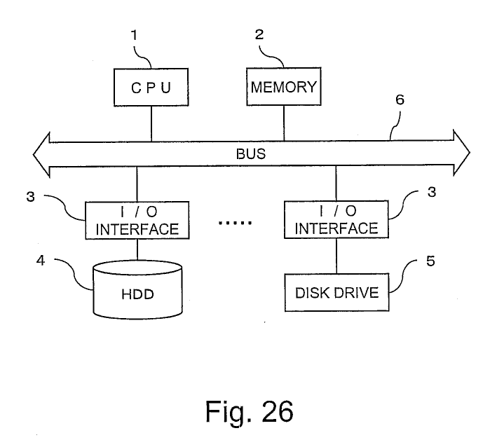

The document management server 60 in this embodiment is typically realized by a general purpose computer by executing a program which describes the respective functions and/or process contents of the above-described respective units. The computer may have, as hardware, a circuit structure comprising, for example, a CPU (central processing unit) 1, a memory (primary memory) 2, various I/O (input/output) interfaces 3, or the like, connected to one another via a bus 6, as shown in FIG. 26. A disk drive 5 is connected to the bus 6, for reading a portable nonvolatile recording medium of various standards, such as a hard disk drive 4, a CD, a DVD, a flash memory, or the like, via the I/O interface 3, for example. The drive 4 or 5 functions as an external memory device as opposed to the memory. A program which describes the content of a process to be carried out in the exemplary embodiment is stored in a fixed memory device, such as the hard disk drive 4, or the like, and installed in the computer. When the program stored in the fixed memory device is read to the memory, and executed by the CPU, the process in the exemplary embodiment is realized. It should be noted that the program described above can be stored on a CD, a DVD, or the like, and alternatively provided via a communication device.

The above-described is an example of a document management server which sends to a notice destination an electronic mail which contains a URL indicative of the registered document file to thereby distribute a document. However, the protection method utilizing a two-step electronic mail is not limited to the case described above, and can be applied to other systems. For example, in a system for providing a limited user with a processing service as, for example, a web server, the protection method using a two-step electronic mail is applicable when the URL of the processing service is notified to the target user by means of an electronic mail. In this case, a processing service, rather than a document file, is protected, with the remaining portions remaining the same.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

What is claimed is:

1. An information processing system, comprising:
a first notice transmission unit that sends to a user first notice information made in correspondence to information or processing service provided by a processing device;
a second transmission unit that sends to the user, when receiving from the user a request which contains at least a part of the first notice information, second notice information made in correspondence to information or processing service corresponding to the first notice information, and
an instruction unit that instructs, when receiving from the user a request which contains at least a part of the second notice information, the processing device to provide the user with information or processing service corresponding to the second notice information.

2. The information process system according to claim 1, wherein, the second notice transmission unit sends second notice information made in correspondence to a restriction condition as the second notice information, and the instruction unit instructs the processing device to provide information or processing service corresponding to the second notice information, when the request which contains at least a part of the second notice information received from the user satisfies the restriction condition corresponding to the second notice information.

3. The information process system according to claim 1, wherein the second notice transmission unit sends the second notice information on which a validity limit is set, and the instruction units instructs the processing device to provide information or processing service corresponding to the second notice information when a time at which the request from the user is received is before the validity limit set on the second notice information contained in the request.

4. The information process system according to claim 3, wherein the second notice transmission unit accepts input of the validity limit by the user, and sends second notice information with the input validity limit set thereon.

5. The information process system according to claim 1, wherein the second notice transmission unit sends the second notice information made in correspondence to secret information, and the instruction units instructs the processing device to provide information or processing service corresponding to the second notice information when the user correctly inputs the secret information made in correspondence to the second notice information in association with the request which contains at least a part of the second notice information.

6. The information process system according to claim 5, wherein the second notice transmission unit accepts input of secret information by the user, and sends second notice information made in correspondence to the input secret information.

7. A computer-readable medium storing a program causing a computer to execute a process for controlling provision of information or processing service, the process comprising:
sending to a user first notice information made in correspondence to information or processing service provided by a processing device;
sending to the user, when receiving from the user a request which contains at least a part of the first notice information, second notice information made in correspondence to information or processing service corresponding to the first notice information, and
instructing, when receiving from the user a request which contains at least a part of the second notice information, the processing device to provide the user with information or processing service corresponding to the second notice information.

8. The computer-readable medium according to claim 7, wherein the sending the second notice information comprises sending second notice information made in correspondence to a restriction condition, and the instructing the processing device comprises instructing the processing device to provide information or processing service corresponding to the second notice information, when the request which contains at least apart of the second notice information received from the user satisfies the restriction condition corresponding to the second notice information.

9. The computer-readable medium according to claim 7, wherein the sending the second notice information comprises sending the second notice information on which a validity limit is set, and the instructing the processing device comprises instructing the processing device to provide information or processing service corresponding to the second notice information when a time at which the request from the user is received is before the validity limit set on the second notice information contained in the request.

10. The computer-readable medium according to claim 9, wherein the sending the second notice information comprises accepting input of the validity limit by the user, and sending second notice information with the input validity limit set thereon.

11. The computer-readable medium according to claim 7, wherein the sending the second notice information comprises sending the second notice information made in correspondence to secret information, and the instructing the processing device comprises instructing the processing device to provide information or processing service corresponding to the second notice information when the user correctly inputs the secret information made in correspondence to the second notice information in association with the request which contains at least a part of the second notice information.

12. The computer-readable medium according to claim 11, wherein the sending the second notice information comprises accepting input of secret information by the user, and sending second notice information made in correspondence to the input secret information.

13. A computer data signal embodied in a carrier wave for enabling a computer to perform a process for controlling provision of information or processing service, the process comprising:
sending to a user first notice information made in correspondence to information or processing service provided by a processing device;
sending to the user, when receiving from the user a request which contains at least a part of the first notice information, second notice information made in correspondence to information or processing service corresponding to the first notice information, and
instructing, when receiving from the user a request which contains at least a part of the second notice information, the processing device to provide the user with information or processing service corresponding to the second notice information.

14. A method for controlling provision of information or processing service, comprising:
sending to a user first notice information made in correspondence to information or processing service provided by a processing device;
sending to the user, when receiving from the user a request which contains at least a part of the first notice information, second notice information made in correspondence to information or processing service corresponding to the first notice information, and
instructing, when receiving from the user a request which contains at least a part of the second notice information, the processing device to provide the user with information or processing service corresponding to the second notice information.
